(19) United States
(12) Patent Application Publication
(10) Pub. No.: US 2009/0074650 A1
(43) Pub. Date: Mar. 19, 2009

(54) METHOD FOR THE PRODUCTION OF SILICON SUITABLE FOR SOLAR PURPOSES

(75) Inventors: Peter Fath, Konstanz (DE); Albrecht Mozer, Burghausen (DE)

Correspondence Address: International IP Law Group, P.O. BOX 691927, HOUSTON, TX, 77269-1927, US

(73) Assignee: Scheuten Solar Holding BV, Venlo (NL)

(21) Appl. No.: 12/158,348

(22) PCT Filed: Aug. 9, 2006
(86) PCT No.: PCT/EP2006/007885

§ 371 Date: Nov. 21, 2008

(30) Foreign Application Priority Data
Dec. 21, 2005 (DE) 10 2005 061 690.9

(51) Int. Cl. C01B 33/023; C01B 33/021; C23F 1/00

(52) U.S. Cl. 423/350; 423/348; 216/99

(57) ABSTRACT

An exemplary method of production of solar grade silicon is disclosed. The method comprises melting the silicon and directionally solidifying the melt. The method additionally comprises forming a crystallization front during the directional solidification, the front having the shape of at least a section of a spherical surface. Also disclosed are a silicon wafer and a solar cell in accordance with an exemplary embodiment of the present invention.

### CROSS REFERENCE TO RELATED APPLICATIONS

Pursuant to 35 U.S.C. § 371, this application is the United States National Stage Application of International Patent Application No. PCT/EP2006/007885, filed on Aug. 9, 2006, the contents of which are incorporated by reference as if set forth in their entirety herein, which claims priority to German (DE) Patent Application No. 102005061690.9, filed Dec. 21, 2005, the contents of which are incorporated by reference as if set forth in their entirety herein.

### BACKGROUND

An exemplary embodiment of the present invention relates to a method for the production of solar grade silicon.

The photovoltaic industry has experienced strong growth in recent years. Since silicon is currently the most important starting material for the production of solar cells or solar modules, demand for this raw material has increased sharply.

Silicon is often found in nature in the form of silicon dioxide, so that in principle, no supply problem exists. However, silicon has to be extracted from silicon dioxide, whereby the requisite silicon has to have a certain degree of purity so that serviceable solar cells with the appropriate efficiency can be manufactured.

In comparison to the degrees of purity required in the electronics industry for the manufacture of semiconductor components such as processors, memories, transistors, etc., the demands made by the photovoltaic industry are considerably less in terms of the purity of the silicon employed for the production of commercial silicon solar cells, especially polycrystalline silicon solar cells. When it comes to the main impurities, this silicon that is suitable for solar applications, so-called solar grade silicon, may only exhibit concentrations of the doping substances (P, B) and metals within the range of 100 ppb (parts per billion) at the maximum, and concentrations of carbon and oxygen within the range of several ppm (parts per million) at the maximum.

Therefore, the purity requirements are lower by a factor of 100 in comparison to those made of the starting material by the electronics industry. For this reason, in the past, the waste material stemming from the electronics industry was further processed in the photovoltaic industry. In the meantime, however, in the wake of the strong growth of the photovoltaic industry, the available amounts of this waste silicon are no longer sufficient to meet the demand. This is why a need exists for methods for a cost-effective production of silicon that fulfills the requirements made by the photovoltaic industry (PV industry), in other words, for solar grade silicon.

The main approach taken in the past for this purpose was one that is also used in the production of silicon for the electronics industry. Here, metallurgical silicon is first made by means of carbothermal reduction of silicon dioxide with carbon. Subsequently, a silane compound is extracted from the metallurgical silicon. After the purification, a chemical process is employed for the deposition of silicon from the gas phase of the silane compound. This silicon is normally melted and cast into ingots or rods to be further processed in the photovoltaic industry.

Aside from this energy-intense and costly method, other methods make use of considerably less pure metallurgical silicon as the starting material. This material is less pure than the requirements made of solar grade silicon by a factor of about 1000. This is why metallurgical silicon is processed in several process steps. These process steps use primarily metallurgical or chemical methods such as passing purge gases—especially oxidizing purge gases and/or acids—through molten metallurgical silicon and/or they involve the addition of slag-forming constituents. Such a method is described, for example, in European patent specification EP 0 867 405 B1.

In both basic methods, however, a silicon melt is cast to form ingots that can be further processed. In this process, the silicon melt solidifies. If directional solidification is performed, the effect of the different solubility of the impurities in the silicon melt and in the silicon solid can be utilized. Many relevant impurities have a higher solubility in the liquid phase than in the solid phase. Consequently, the so-called segregation effect can be utilized in order to purify the silicon material in that, within the scope of a directional solidification, the impurities in the solidification or crystallization front accumulate ahead of the solidified silicon and are driven ahead of the crystallization front. After complete solidification, the impurities are thus concentrated in the area of the silicon ingot to solidify last and they can then be easily separated out. The purification effect can be heightened by consecutively repeating the melting and the directional solidification several times.

As already mentioned, the deposition of silicon out of the vapor phase of silane compounds is cost-intensive and energy-intensive. The processing of metallurgical silicon can be more favorable from the standpoint of energy, but many processing steps have to be carried out in order to meet the purity requirements made of solar grade silicon. CL SUMMARY OF THE INVENTION

An exemplary embodiment of the present invention relates to a method for the production of solar grade silicon, said method allowing an uncomplicated production of solar grade silicon.

An exemplary embodiment of the present invention may relate to more efficiently configuring the directional solidification which, as explained above, is an integral part of every relevant method employed nowadays for the production of solar grade silicon. This is done in that a crystallization front is formed during the directional solidification, said front having the shape of at least a section of a spherical surface.

As a result, the crystallization front has the largest possible surface area. Since the purification effect during the directional solidification depends on the size of the surface area of the crystallization front, this improves the purification effect during a directional solidification. Consequently, solar grade silicon can be produced in a less complicated and thus more cost-effective manner since at least some of the additional purification and processing steps can be dispensed with.

The advantage of the least complicated production of solar grade silicon also has a favorable effect on the silicon disks (wafers) and solar cells made of this material. For this reason, silicon wafers and/or solar cells are advantageously made at least partially of silicon that has been manufactured using the method according to the invention.

Exemplary embodiments of the present invention will be explained in greater detail below with reference to drawings. In this context, it will be assumed throughout that metallurgical silicon is used as the starting material for the directional solidification since the advantages of the invention have a particularly pronounced effect in the case of this impure material. The process steps can be easily transferred to a method in which silicon deposited from the vapor phase of silane compounds serves as the starting material for the directional solidification.

### BRIEF DESCRIPTION OF THE DRAWINGS

FIG. 1 is a process flow diagram showing a method according to an exemplary embodiment of the present invention for the production of solar grade silicon;

FIG. 2 is a process flow diagram showing a method according to an exemplary embodiment of the present invention, comprising the process step of carbothermal reduction of silicon dioxide by means of carbon to form metallurgical silicon;

FIG. 3 is a process flow diagram showing a method according to an exemplary embodiment of the present invention, in which an additional directional solidification with a flat crystallization front is provided;

FIG. 4 is a process flow diagram showing a method according to an exemplary embodiment of the present invention in which additional directional solidification is done with an at least partially spherical crystallization front;

FIG. 5a is a schematic sectional view of a crystallization front having the shape of a section of a spherical surface in which solidification starts here from the surface of the silicon melt in accordance with an exemplary embodiment of the present invention;

FIG. 5b is a schematic sectional view of a semi-spherical crystallization front that starts from a place on the bottom of the crucible in accordance with an exemplary embodiment of the present invention; and

FIG. 5c is a schematic sectional view of a spherical crystallization front in which solidification starts from a place located in the volume of the melt in accordance with an exemplary embodiment of the present invention.

### DETAILED DESCRIPTION OF SPECIFIC EMBODIMENTS

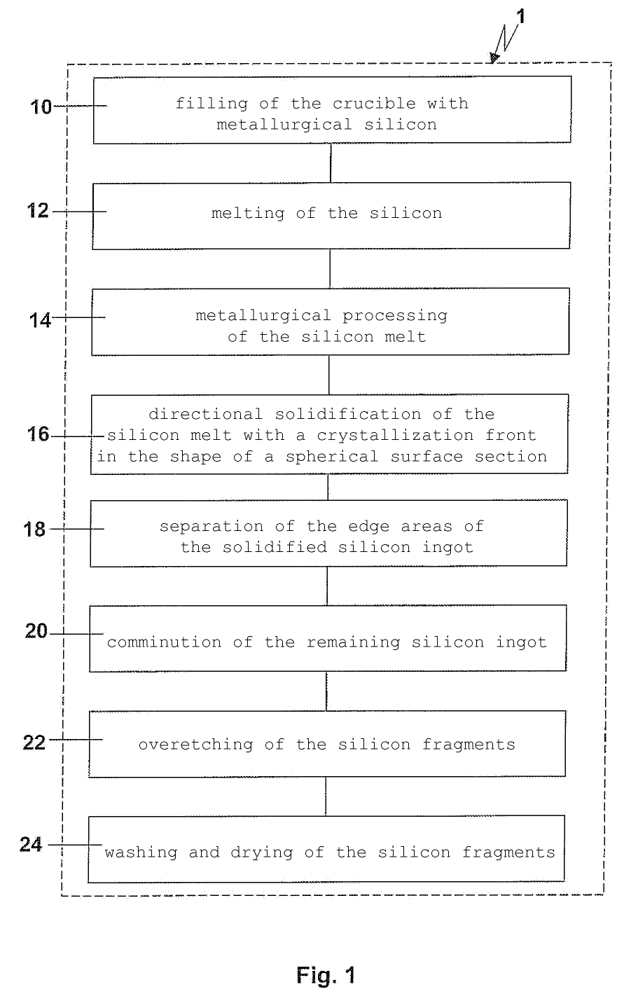

FIG. 1 shows a first exemplary embodiment 1 of the method according to the present invention. Accordingly, first of all, a crucible is filled 10 with metallurgical silicon. The metallurgical silicon is then melted 12 in this crucible. Subsequently, the silicon is processed 14, that is to say, purified, by means of metallurgical methods.

As already mentioned in the introduction, aside from metals, the doping substances boron (B) and phosphorus (P) are the impurities having the greatest significance. A known metallurgical method to remove the phosphorus consists, for example, of subjecting the melt to very high negative pressures in order to thus cause the phosphorus to diffuse out due to its high vapor pressure. In addition, boron can be removed by means of oxidative purification steps. For this purpose, water vapor, carbon dioxide or oxygen is used as the oxidizing purging gas that is passed through the melt (usually mixed with inert gases such as nitrogen or noble gases).

As an alternative or in addition to this, metallurgical purification steps can also be provided in which, as is done in metal production and metal finishing, the melt is mixed with substances that chemically or physically bind undesired impurities and form a slag which, owing to physical properties that differ from those of the silicon melt—for instance, a lower or higher specific density—separate from the silicon melt. For example, the slag can float on the silicon melt due to its lower specific density.

These and similar methods can also be employed for the reduction of the oxygen and/or carbon impurities.

After the processing 14, a directional solidification 16 of the silicon melt is performed, resulting in the formation of a crystallization front that has the shape of at least a section of a spherical surface, in other words, that is at least partially spherical.

Towards this end, a local temperature sink is placed on or in the melt. For instance, the cooled tip of a rod that is positioned on the melt can serve as the temperature sink.

When the materials of the parts of the temperature sink that come into contact with the silicon melt are chosen, care should be taken to ensure that they cannot serve as a source of contamination. In order to prevent this, the surfaces of these parts can be coated, for example, with a heat-resistant dielectric such as silicon nitride, which prevents the transfer of contaminations being critical for the production of solar cells into the melt.

In addition, a graphite coating or a temperature sink made of graphite or other forms of carbon can be employed. As explained above, even though carbon itself is an undesired impurity in the melt, its detrimental influence on the production of solar cells is considerably less pronounced than that of most metallic impurities. Therefore, since the smallest possible contact surface area is created between the carbon and the silicon melt, the carbon contamination is still within a tolerable scope by the end of the production process, in spite of direct contact with the melt.

The local temperature sink serves as a nucleus of crystallization so to speak, so that the crystallization propagates from this nucleus and a spherical crystallization front is established in the melt. In this context, the temperature of the silicon melt should obviously be set before contact with the temperature sink in such a way that the contact with the temperature sink is sufficient to trigger the crystallization.

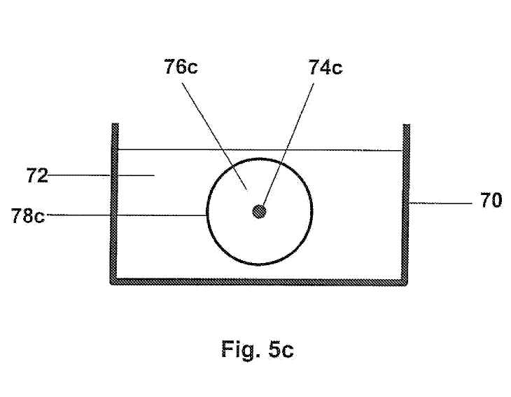

FIGS. 5a to 5c illustrate how a crystallization front is formed having the shape of at least a section of a spherical surface. These figures schematically depict a sectional view of a crucible 70 containing the silicon melt 72.

FIG. 5a illustrates a solidification starting from the surface of the silicon melt. A temperature sink is positioned on the top surface of the melt, where it forms the essentially punctiform crystallization source 74a. This is where the crystallization starts. The crystallization continues in the silicon melt by means of appropriate temperature management, so that a crystallization front 78a in the shape of a semi-spherical shell is formed. Inside of this crystallization front that propagates radially in the silicon melt, there is silicon 76a that has solidified and been purified by the segregation effect. Liquid silicon, in turn, is found outside of the semi-spherical shell 78a.

FIG. 5b illustrates how the solidification takes place starting from the bottom of the crucible 70. The temperature sink here is arranged in the crucible 70 in such a way that the crystallization source 74a is located directly on the bottom of the crucible 70. From there, in turn, a crystallization front 78b having the shape of a semi-spherical shell propagates radial-symmetrically in the silicon melt 72. Solidified silicon 76, in turn, is found inside the semi-spherical shell, whereas the silicon melt 72 is still located in the outside area.

FIG. 5c also shows a solidification that starts from a place in the volume of the melt 72. Therefore, the crystallization source 74c here is in the silicon volume 72. In this case, as can be seen in FIG. 5c, a complete, spherical crystallization front 78c is formed. Solidified silicon 76c is found in the volume enclosed by the crystallization front 78c, whereas the silicon melt 72 is still on the outside.

FIGS. 5a to 5c each show snapshots of the propagating crystallization fronts 78a, 78b, 78c. With the appropriate temperature management, these fronts continue to propagate radial-symmetrically until they have reached the crucible 70. For this reason, the crystallization source 74a, 74b, 74c is preferably positioned in such a manner that, to the greatest extent possible, the crystallization fronts 78a, 78b, 78c reach the walls of the crucible 70 in all spatial directions at the same time. The geometry of the crucible 70 is preferably adapted accordingly, for example, it has a square shape in the case of a crystallization front 78c that is located in the center of the volume of the silicon melt 72. This keeps the solidification time to a minimum. In principle, the crystallization source, however, can be placed at any desired site in the silicon melt 72 or on its surface, for instance, also on the side walls of the crucible 70.

After complete solidification 16 of the melt, impurities at an elevated concentration are present in the areas that solidified last. This is why, as shown in FIG. 1, the edge areas of the solidified silicon ingot are now separated out 18.

Subsequently, the solidified silicon ingot is comminuted 20. This silicon ingot is a polycrystalline silicon that contains crystal boundaries. During the comminution of the silicon ingot, the latter preferably breaks along the crystal boundaries, so that these are situated on the surface of the silicon fragments. Moreover, there is a pronounced accumulation of impurities on the crystal boundaries, so that these likewise lie on the surface of the silicon fragments.

In the next step consisting of the overetching 22 of the silicon fragments, the latter can be loosened and thus removed. This is followed by washing and drying 24 of the silicon fragments in order to remove or neutralize the etching solution.

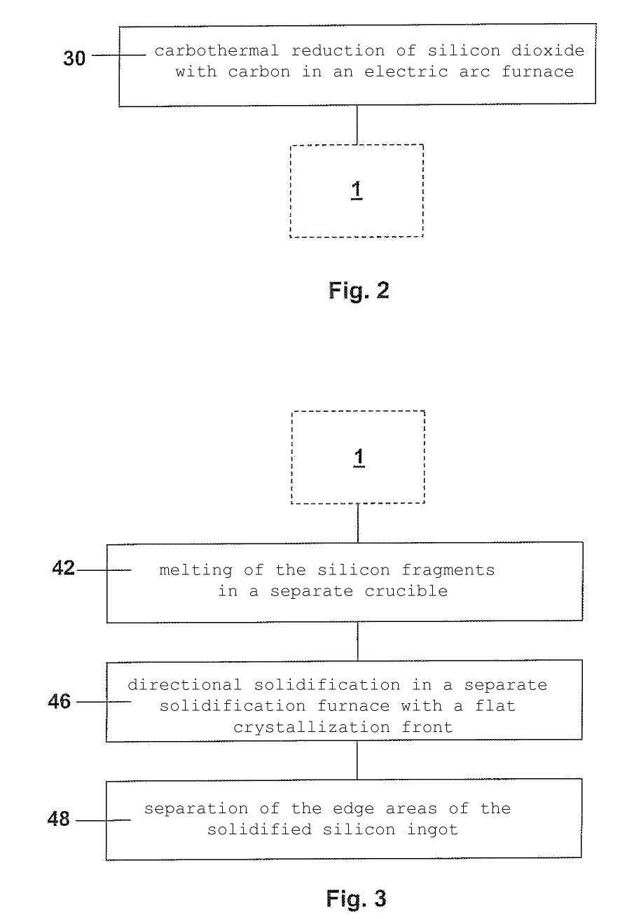

FIG. 2 shows another exemplary embodiment of the method according to the present invention. It comprises all of the process steps of the first exemplary embodiment 1 from FIG. 1, as graphically shown. Here, however, the process steps of the first embodiment 1 are preceded by the carbothermal reduction 30 of silicon dioxide with carbon in an electric arc furnace.

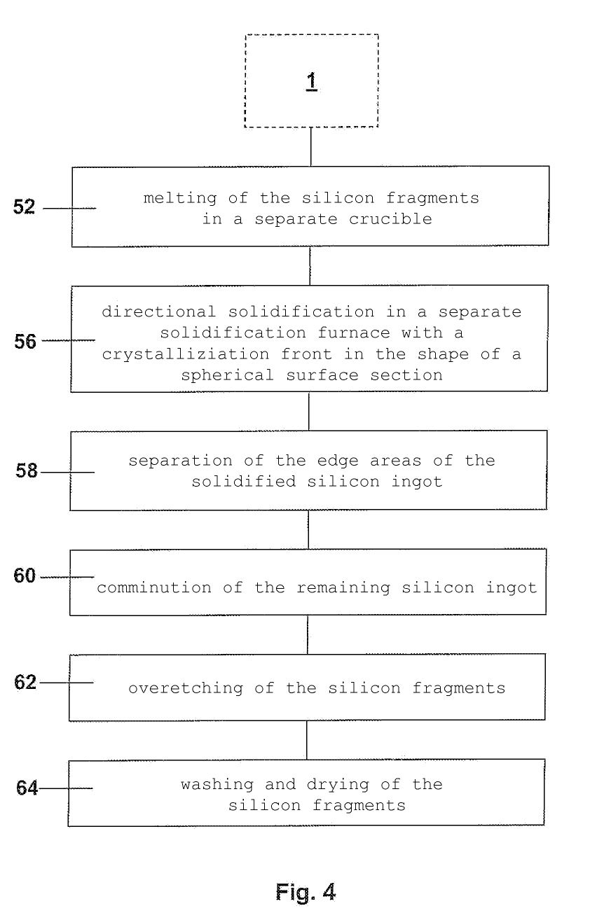

FIG. 3 shows a third exemplary embodiment of the method according to the present invention. This method, in turn, encompasses the process steps of the first embodiment 1 as schematically depicted. Moreover, at the end of the method according to the first embodiment 1, the silicon fragments are once again melted 42 in a separate crucible. This separate crucible has less contamination than the crucible used to melt the metallurgical silicon. This prevents impurities from being transferred into the melt, which consists of the already purified silicon fragments.

This is followed by a directional solidification 46 which, in view of the above-mentioned contamination considerations, is carried out in a separate solidification furnace, a process in which a flat crystallization front is formed. Along the propagating flat crystallization front, the described segregation effects bring about additional purification of the silicon material.

Subsequently, the edge areas of the solidified silicon ingot, in turn, are separated out 48. With a clean or appropriately lined crucible, consideration could also be given to separating out only the bottom and top areas of the solidified silicon ingot, that is to say, the areas that were first and last to solidify, or even only the areas that were last to solidify, since this is where the highest concentration of impurities is present. Generally speaking, however, an elevated contamination is also found in the other edge areas, so that these are advantageously separated out.

This yields additionally purified silicon material. The additional purification described can be necessary especially in order to obtain solar grade silicon material if the starting material is quite heavily contaminated.

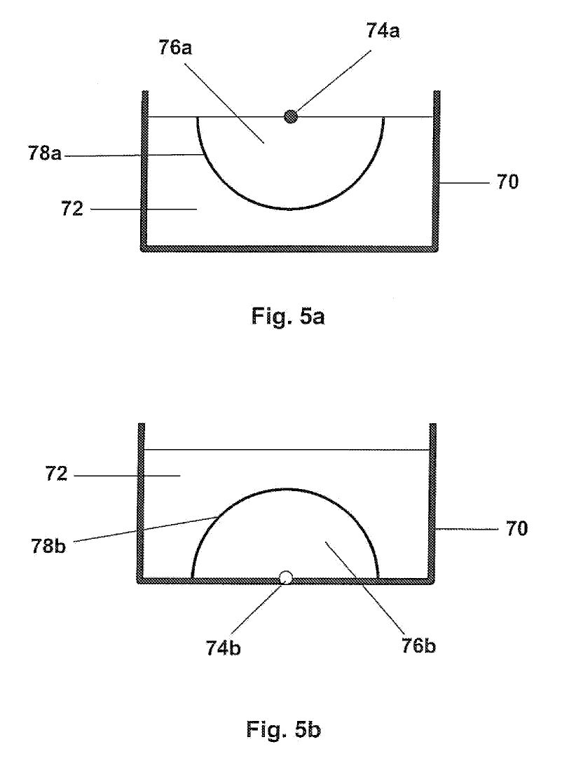

FIG. 4 depicts a fourth exemplary embodiment of the method according to the present invention. Similarly to the third embodiment, the starting point here comprises the process steps of the first embodiment 1. Analogously to the third embodiment, here too, the silicon fragments are once again melted 52 in a separate crucible. Subsequently, a directional solidification 56 is performed whereby, in contrast to the third embodiment, a crystallization front in the shape of at least a section of a spherical surface is formed during the second solidification procedure, which entails the above-mentioned advantages.

This is followed by a renewed separation 58 of the edge areas of the solidified silicon ingot. Subsequently, the remaining silicon ingot is comminuted 60, so that the resulting silicon fragments, which preferably have a diameter of about 5 mm, can be overetched 62. Finally, the silicon fragments are again washed and dried 64. Of course, this additional overetching can also be carried out in one of the other embodiments.

### LIST OF REFERENCE NUMERALS

1 first embodiment

10 filling of the crucible with metallurgical silicon

12 melting of the silicon

14 metallurgical processing of the silicon melt

16 directional solidification of the silicon melt with a crystallization front in the shape of a spherical surface section

18 separation of the edge areas of the solidified silicon ingot

20 comminution of the remaining silicon ingot

22 overetching of the silicon fragments

24 washing and drying of the silicon fragments

30 carbothermal reduction of silicon dioxide with carbon in an electric arc furnace

42 melting of the silicon fragments in a separate crucible

46 directional solidification in a separate solidification furnace with a flat crystallization front

48 separation of the edge areas of the solidified silicon ingot

52 melting of the silicon fragments in a separate crucible

56 directional solidification in a separate solidification furnace with a crystallization front in the shape of a spherical surface section

58 separation of the edge areas of the solidified silicon ingot

60 comminution of the remaining silicon ingot

62 overetching of the silicon fragments

64 washing and drying of the silicon fragments

70 crucible

72 silicon melt

74a crystallization source

74b crystallization source

74c crystallization source

76a solidified silicon

76b solidified silicon

76c solidified silicon

78a crystallization front

78b crystallization front

78c crystallization front

1-21. (canceled)

22. A method for the production of solar grade silicon, comprising:
melting the silicon;
directionally solidifying the melt; and
forming a crystallization front during the directional solidification, the front having the shape of at least a section of a spherical surface.

23. The method according to claim 22, wherein the crystallization front propagates radial-symmetrically in the melt.

24. The method according to claim 22, wherein the solidification starts from the surface of the melt.

25. The method according to either claim 22, wherein the solidification starts from a place located in the volume of the melt.

26. The method according to claim 25, comprising:
disposing the melt in a crucible; and
starting the solidification from a place on the bottom of the crucible.

27. The method according to claim 22, comprising melting metallurgical silicon.

28. The method according to claim 27, comprising extracting the metallurgical silicon using a carbothermal reduction of silicon dioxide with carbon.

29. The method according to claim 28, wherein the carbothermal reduction is carried out in an electric arc furnace.

30. The method according to claim 27, comprising processing the molten metallurgical silicon metallurgically in a processing furnace prior to the solidification, whereby the melt is preferably purified with a purge gas and/or slag-forming constituents are added during the metallurgical processing.

31. The method according to claim 30, wherein the solidification is carried out in the processing furnace.

32. The method according to any of claim 22, comprising removing an edge area on each side of the solidified silicon ingot after the melt has solidified, whereby the edge area is a few centimeters thick.

33. The method according to claim 32, wherein the remaining silicon ingot is comminuted and overetched with an etching solution, whereby silicon fragments resulting from the comminution preferably have a diameter of about 5 millimeters.

34. The method according to claim 33, wherein the silicon fragments are washed and dried after the overetching.

35. The method according to any of claim 32, comprising:
melting the silicon ingot or the silicon fragments again; and
performing another directional solidification.

36. The method according to claim 35, comprising providing a separate crucible in order to repeat the melting

37. The method according to claim 35, comprising performing the melting in a separate solidification furnace.

38. The method according to any of claims 35, comprising removing an edge area on each side of the solidified silicon ingot after the additional directional solidification, whereby the edge area is a few centimeters thick.

39. The method according to claim 38, wherein the remaining silicon ingot is comminuted and overetched with an etching solution, whereby the silicon fragments resulting from the comminution have a diameter of about 5 millimeters.

40. The method according to claim 39, wherein the silicon fragments are washed and dried after the overetching.

41. A silicon wafer manufactured according to a process, the process comprising:
melting silicon;
directionally solidifying the melt; and
forming a crystallization front during the directional solidification, the front having the shape of at least a section of a spherical surface.

42. A solar cell manufactured according to a process, the process comprising:
melting silicon;
directionally solidifying the melt; and
forming a crystallization front during the directional solidification, the front having the shape of at least a section of a spherical surface.
